(19) United States
(12) Patent Application Publication
(10) Pub. No.: US 2005/0115048 A1
(43) Pub. Date: Jun. 2, 2005

(54) Reshaping tool

(76) Inventor: Helmut Reccius, Gummersbach (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/502,693

(22) PCT Filed: Mar. 27, 2003
(86) PCT No.: PCT/EP03/00775

(30) Foreign Application Priority Data
Jan. 30, 2002 (DE) 102034915

(51) Int. Cl. B23P 11/00; B21D 39/03

(52) U.S. Cl. 29/505; 29/428; 29/715; 72/447

(57) ABSTRACT

The invention relates to a forming tool (6) for construction member areas (2), comprising a forming device (10) and a fixing device (8), with which the construction member area (2) to be formed can be fixed relative to the forming device (10). In addition, it relates to a method in which a construction member area (2) is arranged relative to a forming device (10). The device is characterized in that the forming device (10) has a movable arrangement of individually activatable guide elements (26) with shaping bodies (30), it being possible, when a force is applied to the guide elements (26), for the shaping bodies (30) to be pressed in a positively driven manner into the construction member area (2) in such a way that plasticization extending completely or partly over the construction member thickness can be produced by means of the pressing operation, while the construction member area (2) is secured frictionally by the fixing device (8). In the method, a plurality of local deformations of the construction member area (2), which are in each case caused by a pressing operation with a shaping body (26), in the form of plasticization extending completely or partly over the construction member thickness are produced sequentially by means of the forming device (10).

The invention relates to a forming tool for construction member areas, comprising a forming device and a fixing device, with which the construction member area to be formed can be fixed relative to the forming device. In addition, it relates to a method in which a construction member area is arranged relative to a forming device.

Construction member areas are widely used in particular as load-bearing areas, for example in aircraft construction and shipbuilding. They are used there as, for instance, walls, bulkheads, stair landings or also as decks with frequently different cross sections. The construction member thickness of the processed areas, which may have a considerable extent within a range of a few dozen meters, is in this case riot primarily determined by their strength or load-bearing capacity but by official regulations with regard to fire insulation and fire protection.

Rather, in order to stiffen the flat areas and ensure their load-bearing capacity, stiffeners are welded onto the side opposite to the load-bearing area. When these stiffeners are being welded on, “welding distortion” occurs, that is to say a shrinkage process which is caused by the welding operation and causes undesirable waviness of the flat areas, a factor which in turn necessitates time-consuming and costly rework of precisely these areas. This waviness may assume dimensions which can be recognized with the naked eye. Furthermore, said unevenness gives rise to further problems if the parts produced from the construction member areas are critical with regard to their accuracies of fit when being fitted into the entire structure.

Filling compound, for example, is often used for compensating for the unevenness, and the use of this filling compound, in addition to the increase in cost, entails an undesirable displacement of the center of gravity within the entire structure into which the areas are fitted. Also occasionally used for reducing the unevenness are methods in which the construction member area to be processed is restrained during the welding operation, although the large dimensions of the areas to be processed prove to be disadvantageous, or also laser welding processes, which certainly reduce the welding distortion, but involve high production costs for the plant. Furthermore, other straightening processes are also used when reworking construction member areas, such as, for instance, flame straightening or straightening rolling methods, and finally it is possible, for the deformation, to subsequently apply overall bending moments to the construction member area by means of a press, a factor which again entails a disadvantage in that these bending moments, given the magnitude of the requisite moments, require large displacements of the tool or large loads.

The object of the present invention is therefore to provide a device and a method, by means of which construction member areas, while avoiding the disadvantages just cited, can be formed in a simple and cost-effective manner, so that the requisite flatness of the areas is ensured.

The object is achieved according to the invention by a forming tool of the type mentioned at the beginning, in which the forming device has a movable arrangement of individually activatable guide elements with shaping bodies, it being possible, when a force is applied to the guide elements, for the shaping bodies to be pressed into the construction member area in such a way that plasticization extending completely or partly over the construction member thickness can be produced by means of the pressing operation, while the construction member area is secured frictionally by the fixing device.

In the forming tool according to the invention, a fixing device therefore positions the construction member area to be processed or the section of the construction member area relative to a forming device and then frictionally secures said construction member area. The forming device arranged above the construction member area has a movable arrangement of individually activatable guide elements with shaping bodies, to which a force can be applied. Individually or in groups, these guide elements, after application of the respective force, guide the shaping body attached to them from its spaced-apart position toward the construction member area, where the shaping body is pressed into the construction member area. The pressing operation, which constitutes an operation for the partial shaping of the construction member area, leads to the shape of the construction member area being restored by the introduction of the shaping body into the construction member area, so that the unevenness originally present is compensated for. This stems from the fact that plasticization of the material is produced by this introduction of the shaping body, said plasticization extending entirely or partly over the construction member thickness.

In an advantageous development of the forming tool, the forming device is attached to a movable slide. As a result, the forming device can be traversed relative to the construction member area secured by means of the fixing device without the securing having to be neutralized and the construction member area having to be fixed again, so that, in this way, defined and economical work is possible over larger areas.

In a further advantageous design, the forming device and/or the movable slide are/is guided on a rail attached to a carriage, the carriage being traversable relative to the construction member area. The attachment to such a carriage, which can be moved over the construction member area, for instance on wheels, makes it possible for the forming device to be moved toward any desired locations of the area to be processed, whereas the guidance of the forming device and/or of the slide on a rail ensures an exact one-dimensional movement of the forming tool itself in a linear direction relative to the construction member area, for instance parallel to a weld in the construction member area, when the carriage is in a stationary state. In this case, the optional attachment of a rigid beam with the arrangement of the guide elements on the carriage is also conceivable, in which case a relative movement with regard to the construction member area would then take place solely on account of the movement of the carriage.

For this purpose, the slide can advantageously be moved by means of an actuating device which can be operated by a cylinder. The actuating device provides for the drive of the slide and traverses the latter into the desired position, it being possible, in addition to a drive via a hydraulic or pneumatic cylinder, to also provide other actuating elements, such as, for instance, electric motors or the like.

The guide elements of the forming device of a forming tool according to the invention are preferably arranged at a lateral distance apart in a first direction, so that they form a one-dimensional movable arrangement. When tracing a forming section which essentially follows a straight line and runs, for example, along a weld, this permits quick and effective processing of the construction member area. In an advantageous development, the guide elements of the forming device are arranged at a lateral distance apart in a further direction running essentially perpendicularly to the first direction. In this way, first of all, for example, a plurality of arrangements pointing in one direction can be operated parallel to one another. However, it is also not necessary for the arrangement in a further direction to follow a particular direction, but rather said arrangement can be adapted to the forming task and can thus be designed for the specific situation. However, the tracing of non-rectilinear lines which is possible in this case can also be effected by defined activation of one of a plurality of parallel arrangements of guide elements, for example by means of a process computer.

For the trouble-free sequence of the forming operation, it is advantageous that a plurality of guide elements can be jointly activated in such a way that symmetrical loading of the construction member can be produced during the pressing operation relative to an imaginary plane of symmetry located between the guide elements. If, for instance, in an arrangement of eight guide elements, the first and eighth guide elements or the first, second, seventh and eighth guide elements are acted upon, uniform, axial loading occurs with regard to both the processing tool and the processed workpiece. This has the advantage that both canting of the construction member and disturbance at the forming tool, with the accompanying losses of time and/or material, are avoided.

To operate the guide elements, each of them can advantageously be activated via a pressure cylinder. Given appropriate activation of the pressure cylinder, the energy stored in said pressure cylinder is released and delivered to the guide element, which in turn is accelerated together with the shaping body in the direction of the construction member area. In this case, the guide elements are preferably designed in the form of a punch with restoring spring, the punch guiding the shaping body and the restoring spring ensuring that the punch can be returned into its initial position after the pressing operation. The actuation of the guide element is in this case not restricted to the operation by means of a pressure cylinder; instead of the latter and the restoring spring, operation with a double-acting hydraulic cylinder with valve control, for example, is also conceivable.

To produce the impression and the plasticization associated therewith, it is advantageous for the ends of the shaping bodies which can be pressed into the construction member area to be designed in cross section in the form of a sector of a circle or of an ellipse. However, the type and depth of the impression to be produced and also the shape of the shaping body, in the same way as the force to be applied, depend on the area to be processed and its material, for instance its modulus of elasticity. These parameters for achieving the desired forming result can be determined within the course of preliminary tests, and it is then of course also possible to use shaping bodies of other designs.

To secure the construction member area to be processed, the fixing device, in a preferred embodiment, has a means of producing magnetic forces. When magnetic metallic materials are used for the construction member areas, the latter can be arranged and fixed with said means. In addition, it is advantageous if the fixing device, at the same time or alternatively, has a means of producing vacuum forces. This means is used in the form of a suction device when it is necessary, for example, to arrange and secure a construction member area of aluminum.

Since the plate thickness of the construction member area to be processed can partly vary considerably on account of thickness tolerances, it is advantageous if the fixing device is movably mounted on a rail in order to compensate for unevenness of the construction member area. Despite the irregularity of the construction member area, the movable mounting permits a flat arrangement of the construction member area relative to the guide elements and ensures uniform processing.

Finally, in an advantageous development, at least one sensor system is provided on the forming tool for tracing relevant parameters. The sensor system may involve, for example, optical sensors for tracing the flatness of the area or of the weld. The signals produced by the sensors can in turn be fed back as control parameters to the control and then have a direct effect on the next working step during the forming operation.

Furthermore, the object is also achieved according to the invention by a method in which a plurality of local deformations of the construction member area, which are in each case caused by a pressing operation with a shaping body, in the form of plasticization extending completely or partly over the construction member thickness are produced sequentially by means of the forming device. The construction member area is subjected to partial shaping by shaping bodies being pressed into the area by means of a forming device and by plasticization of the construction member material occurring within a straightening zone assigned to the impression of the shaping bodies. This plasticization may extend over the entire construction member thickness, as a result of which the material is “thoroughly plasticized” in the region of the impression of the shaping body. This enables unevenness to be removed which occurs at the construction member area during the production process. Even if the method can be carried out by integration of the corresponding forming device on a normal bending press, overall bending moments of the area to be processed only play a subordinate role in this process, since only brief local loading of the material occurs. If a bending press is used in the method, however, its cross section can be considerably reduced, since substantially lower forces are used than during overall bending of an entire area.

To process a construction member area section by section, the forming device used is advantageously a one- or two-dimensional arrangement of laterally spaced-apart guide elements with shaping bodies attached thereto. This arrangement permits sequential, local processing of a plurality of defined points of the surface, with stationary guide elements. The arrangement of guide elements is preferably fastened to a traverse means and, guided on the latter, is displaced gradually relative to the construction member area. The guide elements can be moved relative to the construction member area by the traverse means, so that a larger region of the construction member area can be processed without the fixing of the area changing in any way. Finally, it is advantageous if the forming device and a fixing device are part of a complete device which is arranged above the construction member area in defined positions. With the construction member area being released from the securing of the fixing device, the complete device can be traversed relative to the construction member area, so that ultimately, after renewed fixing, any desired positions on the area can be reached and processed by the forming device.

In the method according to the invention, for quick and trouble-free processing of large areas, a plurality of guide elements are activated simultaneously in such a way that they produce uniform loading of the construction member relative to an imaginary plane of symmetry between the guide elements. Accordingly, the entire arrangement of the forming tool is also uniformly loaded, which makes this entire arrangement less susceptible to trouble overall.

Since the plasticization of the material of the construction member area is based on the rapid application of forces which are small compared with other forming operations, it is advantageous if the pressing and plasticizing operation of a guide element takes place during a period of 0.01 to 5 seconds. This pressing and plasticizing operation preferably takes place during a period of 0.05 to 0.5 seconds and in particular preferably within one tenth of a second. Within this period, impressions are produced in the construction member area by the shaping bodies, attached to the guide elements, by a force being applied to said shaping bodies, the penetration depth of the shaping bodies, depending on the respective material, varying, for example, within the range of a few hundredths of a millimeter, so that the impression itself makes no substantial contribution to unevenness of the area, whereas unevenness of the area of larger dimensions is removed by the plasticization.

In order to ensure reliable and defined processing of the area with a quick change of region, provision is made in the method according to the invention for magnetic or vacuum forces to be used during the arrangement of the construction member area. By means of these forces, the area to be processed can be secured in a simple manner and released again without complicated fixing elements having to be provided.

Finally, for reasons of environmental protection and occupational safety, it is advantageous that, in the method, the forming operation takes place relatively quietly compared with other forming processes. Since, in the method according to the invention, always only a section of the construction member area is briefly affected, and only defined points in this section are briefly affected simultaneously, the generation of noise during the processing of the construction member areas is markedly reduced compared with overall forming methods.

The invention is explained below with reference to any exemplary embodiment shown in the drawing, in which:

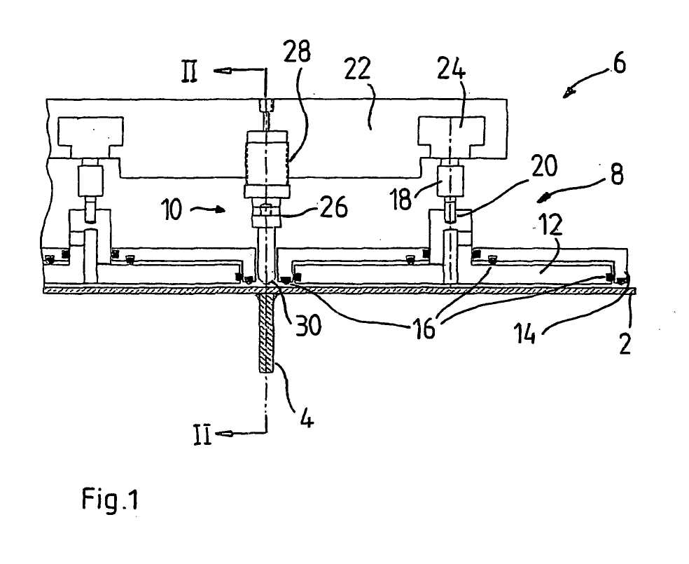

FIG. 1 shows an end cross section of a forming tool arranged above a construction member area and having a forming and a fixing device,

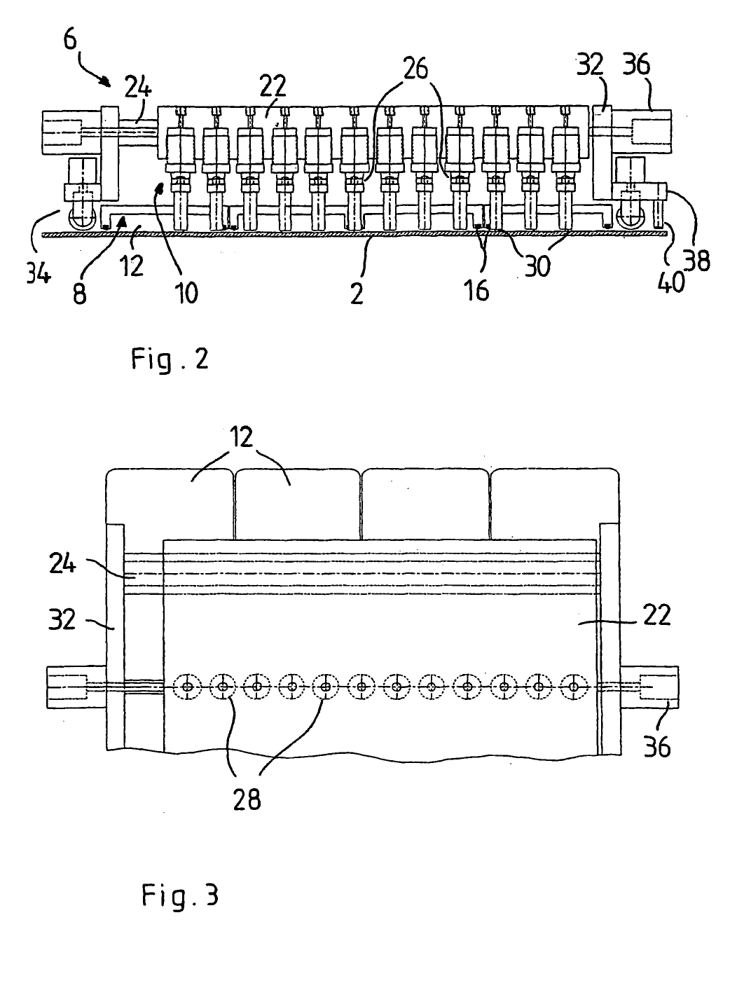

FIG. 2 shows a longitudinal section through the forming tool from FIG. 1 along line II-II,

FIG. 3 shows a plan view from above of the forming tool.

FIG. 1 shows first of all a region of a construction member area 2, to the underside of which a reinforcing bar 4 is attached in a perpendicularly projecting manner. By the reinforcing bar 4 being attached by means of a welding process, welding distortion of the material occurs inside the welding zone. Therefore, on that surface side of the construction member area 2 which faces away from the reinforcing bar, a weld (not shown in the drawing) runs parallel to the reinforcing bar 4 in a perpendicular direction to the drawing plane.

Arranged above the construction member area 2 is a forming tool 6 which has a fixing device 8 and a forming device 10. In this case, the fixing device 8 consists of a parallel arrangement of laterally spaced-apart suction means with vacuum chambers 12 of essentially rectangular cross section. The latter are put onto the construction member area and, after evacuation of the vacuum chambers 12, are able to hold and fix the area to be processed and to arrange it relative to the forming device 10. In this case, that region of the construction member area which is held by the respective vacuum chamber 12 forms the missing wall piece of the otherwise open chamber. Seals 16 are provided at those ends of the wall pieces 14 of the vacuum chamber 12 which face the construction member area 2 and also at further locations at further which are important for ensuring the vacuum.

To compensate for unevenness of the construction member area, the suction device is to be flexible, for which purpose it is held on a punch mounting 18 with an articulated connecting piece 20. The punch mounting 18 itself is in this case attached to that side of a rail 24 which faces the construction member area 2, on which rail 24 a slide 22 is traversable in such a way as to be guided perpendicularly to the drawing plane. Arranged between the punch mountings 18, a guide element 26 with pressure cylinder 28 and shaping body 30 is arranged on the slide 20 in such a way as to face the construction member area 2. When the pressure cylinder 30 is actuated, the guide element 26 is accelerated and is moved together with the shaping body 30 attached thereto toward the construction member area 2, in the course of which they are directed through the gaps between the vacuum chambers 12. The gaps between the chambers correspond in this case to the straightening zones to be processed, in which a forming operation is to take place. After the shaping body has been pressed into the straightening zone of the construction member area, the guide element 26 is returned with the shaping body 30 into its initial position by a spring (not shown) and can then be acted upon again for a following forming operation.

FIG. 2 shows a movable arrangement of laterally spaced-apart guide elements 26 which are arranged in a row and are movable on the slide 22 above the construction member area 2. The slide 22 runs on a rail 24, which extends between two perpendicular supporting webs 32 belonging to the chassis of a carriage 34 and is secured to the supporting bars 32. On the sides of the supporting bars 32 which face away from the rail 24, the actuating devices 36 for the slide are arranged at the level of the rail 22, whereas transverse bars running parallel to the construction member area and having mountings for attaching wheels 38 are located on the bottom end of the supporting bars 32.

During a movement of the slide, the arrangement of guide elements 26 is traversed linearly, that is to say in a horizontal direction, so that the guide elements 26 together with the shaping bodies 30 can be brought along the gaps left by the vacuum chambers 12 on the construction member area 2 from one press-in position into the next. An imaginary plane of symmetry can be inserted between the sixth and seventh of the twelve guide elements 26 shown, relative to which plane of symmetry a plurality of symmetrically arranged guide elements can be acted upon simultaneously, so that symmetrical loading is produced with regard to both the construction member area 2 and the entire arrangement. In this case, the activation of different combinations of guide elements 26 arranged symmetrically relative to the plane of symmetry is conceivable both simultaneously and successively. By means of the wheels 38 located on the carriage 34, the entire arrangement with forming device and fixing device can be moved relative to the construction member area. To this end, the construction member area 2 secured by means of the vacuum chambers 12 must first of all be released by admission of air in order to be fixed again after the displacement by renewed evacuation. After that, the processing of the construction member area can be continued at another position of the forming tool.

Furthermore, a sensor 42 is provided in a region of the carriage 34 in which one of the wheels 40 is also attached, that is to say, for instance, at one of the transverse bars 38. This sensor 42, for example as an optical sensor, traces the course of the weld over the construction member area 2. If the course of the weld, its end or other properties are not as prescribed, a signal generated by the sensor can be used for influencing the activation of the guide elements 26 or, for instance, the traverse path of the slide 22 or the carriage 34.

In FIG. 3, the forming tool is shown in a view from above without the construction member area. The linear, one-dimensional arrangement of the guide elements 26 on the slide 22 can be seen in this figure, this arrangement being traversable over the desired straightening zone of the construction member area 2. The guidance of the slide 22 on the rail 24 and the securing of the rail 24 to the supporting bars 32 can also be seen. The actuating devices 36 for moving the slide 22 are attached to the side of the supporting bars 32 which faces away from the rail 24 and the slide 22. The punch mountings 18 with articulated connecting pieces 20, which hold the vacuum chambers 12 of the suction device, are located on that side of the rail 24 which faces away from the viewer. A plurality of these vacuum chambers 12, the top side of which faces the viewer in FIG. 3, are arranged adjacently next to one another in the horizontal direction and have an essentially rectangular cross section with rounded-off corner regions. FIG. 3 also makes it clear that a forming tool according to the invention can basically be positioned at any desired locations of an extended construction member area 2 for processing unevenness.

Forming Tool

List of Designations

2 Construction member area
4 Stiffening bar
6 Forming tool
8 Fixing device
10 Forming device
12 Vacuum chamber
14 Wall piece
16 Seal
18 Punch mounting
20 Articulated connecting piece
22 Slide
24 Rail
26 Guide element
28 Pressure cylinder
30 Shaping body
32 Supporting bar
34 Carriage
36 Actuating device
38 Transverse bar with mounting
40 Wheel
42 Sensor

1. A forming tool for construction member areas, comprising a forming device and a fixing device, with which the construction member area to be formed can be fixed relative to the forming device, characterized in that the forming device (10) has a movable arrangement of individually activatable guide elements (26) with shaping bodies (30), it being possible, when a force is applied to the guide elements (25), for the shaping bodies (30) to be pressed in a positively driven manner into the construction member area (2) in such a way that plasticization extending completely or partly over the construction member thickness can be produced by means of the pressing operation, while the construction member area (2) is secured frictionally by the fixing device (8).

2. The forming tool as claimed in claim 1, characterized in that the forming device (10) is attached to a movable slide (22).

3. The forming tool as claimed in claim 1 or 2, characterized in that the forming device (10) and/or the movable slide (22) are guided on a rail (24) attached to a carriage (34), the carriage (34) being traversable relative to the construction member area (2).

4. The forming tool as claimed in claim 2, characterized in that the slide (22) can be moved by means of an actuating device (36) which can be operated by a cylinder.

5. The forming tool as claimed in claim 1, characterized in that the guide elements (26) of the forming device (10) are arranged at a lateral distance apart in a first direction.

6. The forming tool as claimed in claim 5, characterized in that the guide elements (26) of the forming device (10) are arranged at a lateral distance apart in a further direction running essentially perpendicularly to the first direction.

7. The forming tool as claimed in claim 1, characterized in that a plurality of guide elements (26) can be jointly activated in such a way that symmetrical loading of the construction member can be produced during the pressing operation relative to an imaginary plane of symmetry located between the guide elements (26).

8. The forming tool as claimed in claim 1, characterized in that each guide element (26) can be activated via a pressure cylinder (28).

9. The forming tool as claimed in claim 1, characterized in that the guide elements (26) are designed in the form of a punch with restoring spring.

10. The forming tool as claimed in claim 1, characterized in that the ends of the shaping bodies (30) which can be pressed into the construction member area are designed in cross section in the form of a sector of a circle or of an ellipse.

11. The forming tool as claimed in claim 1, characterized in that the fixing device (8) has a means of producing magnetic forces.

12. The forming tool as claimed in claim 1, characterized in that the fixing device (8) has a means of producing vacuum forces.

13. The forming tool as claimed in claim 3, characterized in that the fixing device (8) is movably mounted on the rail (24) in order to compensate for unevenness of the construction member area.

14. The forming tool as claimed in one of claim 1, characterized in that at least one sensor system is provided on the tool (2) for tracing relevant parameters.

15. A method of forming construction member areas, in which a construction member area is arranged relative to a forming device, characterized in that a plurality of local deformations of the construction member area (2), which are in each case caused by a pressing operation with a shaping body (30), in the form of plasticization extending completely or partly over the construction member thickness are produced sequentially by means of the forming device (10).

16. The method as claimed in claim 15, characterized in that the forming device (10) used is a one- or two-dimensional arrangement of laterally spaced-apart guide elements (26) with shaping bodies (30) attached thereto.

17. The method as claimed in claim 16, characterized in that the arrangement of guide elements (26) is fastened to a traverse means and, guided on the latter, is displaced gradually relative to the construction member area (2).

18. The method as claimed in claim 15, characterized in that the forming device (10) and a fixing device (8) are part of a complete device which is arranged above the construction member area (2) in defined working positions.

19. The method as claimed in claim 15, characterized in that a plurality of guide elements (26) of the forming device (10) are activated simultaneously in such a way that they produce uniform loading of the construction member relative to an imaginary plane of symmetry between the guide elements (26).

20. The method as claimed in claim 15, characterized in that the pressing and plasticizing operation of a guide element (26) takes place during a period of 0.01 to 5 seconds.

21. The method as claimed in claim 15, characterized in that the pressing and plasticizing operation of a guide element (26) takes place during a period of 0.05 to 0.5 seconds.

22. The method as claimed in claim 15, characterized in that the pressing and plasticizing operation of a guide element (26) takes place during one tenth of a second.

23. The method as claimed in claim 15, characterized in that magnetic or vacuum forces are used during the arrangement of the construction member area (2).

24. The method as claimed in claim 15, characterized in that the forming operation takes place relatively quietly compared with other forming processes.
